(19) United States
(12) Patent Application Publication
(10) Pub. No.: US 2003/0060290 A1
(43) Pub. Date: Mar. 27, 2003

(54) Elastic coupling with wirework reinforcement

(75) Inventors: Masahiro Shimizu, Kasugai-Shi (JP); Noriaki Yoshii, Nagoya-Shi (JP); Michihiro Hiramatsu, Inuyama-Shi (JP)

Correspondence Address: BURR & BROWN, PO BOX 7068, SYRACUSE, NY, 13261-7068, US

(73) Assignee: Tokai Rubber Industries, Ltd., Komaki-Shi (JP)

(21) Appl. No.: 10/226,914

(22) Filed: Aug. 23, 2002

(30) Foreign Application Priority Data
Sep. 26, 2001 (JP) 2001-294568
Mar. 28, 2002 (JP) 2002-092316

(51) Int. Cl. F16D 3/78

(52) U.S. Cl. 464/93

(57) ABSTRACT

An elastic coupling for elastically connecting two rotary shaft members through respective first and second fixing members fixed thereto, wherein a main rubber body to be interposed between the shaft members has first and second through-holes which are alternately arranged along a circle having a center on rotation axis of the main rubber body and through which the first and second fixing members are inserted, and a reinforcing member embedded within the main rubber body and consisting of a wirework structure formed by bending a spring steel wire, the wirework structure including envelope portions surrounding circumferential portions of the respective through-holes which are located outside of the circle and which correspond to at least a half of the circumference of each through-hole, the wirework structure further including spring portions each connecting the adjacent envelope portions and generating a resilient force resisting a relative displacement of the adjacent envelope portions in the circumferential direction of the circle.

This application is based on Japanese Patent Applications No. 2001-294568 filed on Sep. 26, 2001 and No. 2002-092316 filed Mar. 28, 2002, the contents of which are incorporated hereinto by reference.

### BACKGROUND OF THE INVENTION

1. Field of the Invention

The present invention relates in general to an elastic coupling, and more particularly to an elastic coupling arranged to elastically connecting two rotary shaft members such that a rotary motion or torque is transmitted from one of the two rotary shafts to the other.

2. Discussion of Related Art

As an example of a coupling for connecting two shaft members, there is known an elastic coupling arranged to elastically or flexibly connecting two rotary shaft members such that a rotary motion or torque is transmitted from one these two rotary shaft members to the other. This elastic coupling is suitably used to transmit a drive torque between the two rotary shaft members, while minimizing the transmission of a vibration between the two rotary shaft members. For instance, such an elastic coupling is disposed at a point of connection of two shaft portions of a steering column (post) or a propeller shaft in an automotive vehicle, for example. These two shaft portions are considered to be the two rotary shaft members indicated above.

It is desired to construct the elastic coupling so that the elastic coupling exhibits a relatively soft spring characteristic with respect to a load applied thereto in its axial direction, namely, a relatively low axial stiffness, for ensuring excellent vibration damping characteristics, and exhibits a relatively hard spring characteristic with respect to a torsional load, namely, a relatively high torsional stiffness, for ensuring a high response of transmission of a rotary motion or torque from the output shaft portion to the input shaft portion. Where the elastic coupling is used as a steering coupling arranged to elastically connect two shaft portions of a steering column (steering post) of an automotive vehicle, in particular, the elastic coupling is required to exhibit a sufficiently high degree of torsional stiffness, for assuring a high response of a steering system to manipulation of a steering wheel by the operator of the vehicle.

For example, the requirement indicated above is conventionally met by a so-called cord-reinforced steering coupling widely used for an automotive vehicle. This cord-reinforced steering coupling includes a generally planar main rubber body in the form of a disc, and reinforcing members which reinforce the main rubber body. The main rubber body is interposed between two rotary shaft members in the form of an input shaft portion and an output shaft portion of the steering column or post, such that the main rubber body is rotated together with the two rotary shaft members. The main rubber body has input-shaft fixing through-holes through which respective fixing members of the input shaft portion are inserted to fix the input shaft portion to the main rubber body, and output-shaft fixing through-holes through which respective fixing members of the output shaft portion are inserted to fix the output shaft portion to the main rubber body. These input-shaft and output-shaft through-holes are located alternately along a circle which has a center on the axis of rotation of the main rubber body (the axes of rotation of the input and output shaft portions). Each of the reinforcing members consists of a coil of a relatively long synthetic fiber cord, which connects portions of the main rubber body which define the adjacent input-shaft and output-shaft through-holes which are adjacent to each other in the rotating direction of the main rubber body. In the cord-reinforced steering coupling thus constructed, the reinforcing members formed of the synthetic fiber cords function to reinforce the main rubber body, so as to increase the torsional stiffness to a desired value, while the main rubber body exhibits a considerably soft spring characteristic with respect to the load applied thereto in its axial direction, owing to its compression or shearing deformation.

In the known cord-reinforced elastic coupling using the synthetic fiber cords as the reinforcing members, however, the synthetic fiber cords must be wound a large number of times to form a coil having a sufficiently high tensile strength, so that the manufacture of the reinforcing members and the elastic coupling tends to be cumbersome and accordingly costly. Further, the coils of the synthetic fiber cords tend to have a variation in their winding condition, and relatively easily suffer from thermal contraction during vulcanization of the main rubber body, or dislocation with respect to the through-holes due to the vulcanization pressure, so that the elastic coupling tends to be inconsistent in its torsional stiffness or its spring characteristic in the rotating direction. Thus, the reinforcing members used in the known elastic coupling are not satisfactory in the stability of maintaining its torsional stiffness.

The present inventors made extensive studies in an effort to solve the drawbacks experienced in the prior art elastic coupling which use synthetic fiber cords. The studies resulted in the conception of forming a reinforcing member by using a wire of a spring steel in place of the synthetic fiber cords used in the prior art. The reinforcing member for increasing the torsional stiffness of the elastic coupling is formed by suitably bending the spring steel wire, and is embedded within a generally planar main rubber body. However, the studies also revealed some drawbacks such as local stress concentration and damage of the reinforcing member after a long use of the elastic coupling, and consequent deterioration of the durability of the elastic coupling, if the structure of the reinforcing member formed by bending the steel wire is not adequately designed.

### SUMMARY OF THE INVENTION

The present invention was made on the basis of the inventors' finding indicated above. It is therefore an object of the present invention to provide an elastic coupling which is easy and economical to manufacture, consistent in its torsional stiffness, and highly durable.

The first object indicated above may be achieved according to the principle of this invention, which provides an elastic coupling to be interposed between a first rotary shaft member and a second rotary shaft member which are provided at respective first and second ends with respective first and second sets of fixing. members fixed thereto, the elastic coupling comprising a generally planar main rubber body to be interposed between the first and second rotary shaft members, and a reinforcing member embedded within the main rubber body to reinforce the main rubber body for increasing a torsional stiffness of the main rubber body with respect to a torsional load applied thereto in a direction of rotation thereof, the main rubber body having a plurality of first through-holes and a plurality of second through-holes which are alternately arranged at a predetermined angular spacing interval along a circle having a center on a rotation axis of the main rubber body, the fixing members of the first set being fixedly inserted through the first through-holes while the fixing members of the second set being fixedly inserted through the second through-holes, whereby the first and second rotary shaft members are elastically connected to each other by the elastic coupling such that the main rubber body is rotatable with the first and second rotary shaft members, wherein an improvement comprises: the reinforcing member consisting of a wirework structure formed by bending a single wire of a spring steel, so as to surround the first and second through-holes; the reinforcing member including a plurality of envelope portions surrounding circumferential portions of the respective first and second through-holes, which circumferential portions are located radially outwardly of the circle and correspond to at least a half of a circumference of each of the through-holes, the envelope portions being spaced apart from circumferential surfaces of the respective first and second through-holes in a radial direction of each through-hole, by respective rubber layers which partially defines the circumferential surfaces; and the reinforcing member further including a plurality of spring portions each of which connects adjacent ones of the plurality of envelope portions which are adjacent to each other in a circumferential direction of the circle, each of the spring portions generating a resilient force resisting a relative displacement of the adjacent ones of envelope portions when the relative displacement takes place in the circumferential direction.

In the steering coupling constructed according to the present invention as described above, the reinforcing member is positioned relative to the generally planar main rubber body such that each of the envelope portions of the reinforcing member surrounds a circumferential portion of the corresponding first or second through-hole which is located radially outwardly of the above-indicated circle (along which the through-holes are arranged) and which corresponds to at least a half of the circumference of the through-hole. When the two rotary shaft members are displaced in the radial direction relative to each other at their ends at which the rotary shaft members are flexibly attached to the elastic coupling with the first and second fixing members fixedly inserted through the respective first and second through-holes, the adjacent envelope portions partially surrounding the adjacent first and second through-holes are forced by the fixing members to be displaced relative to each other in the circumferential direction of the above-indicated circle At this time, the spring portions generate resilient forces resisting the relative displacement of the adjacent envelope portions, thereby minimizing an amount of torsional deformation of the main rubber body due to the relative displacement of the two rotary shaft members in a plane perpendicular to the rotation axis of the main rubber body. Thus, the reinforcing member functions to increase the torsional stiffness of the elastic plate with respect to a torsional load applied thereto in its direction of rotation about its axis.

Further, the reinforcing member embedded within the main rubber body of the present elastic coupling is a wirework structure formed of a single wire of a spring steel. This wirework structure can be formed more easily than the conventionally used reinforcing member consisting of a coil of a synthetic fiber cord, which is formed by winding the cord a large number of times to increase the tensile strength of the coil.

In addition, the wirework structure of the reinforcing member, which is formed by simply bending the spring steel wire, does not suffer from the drawbacks experienced by the conventional reinforcing member of the synthetic fiber cord, such as a variation in its configuration, thermal contraction during vulcanization of the main rubber body, and dislocation with respect to the through-holes due to the vulcanization pressure. Accordingly, the elastic coupling including the reinforcing member embedded within the main rubber body is held consistent in its torsional stiffness or its spring characteristic in the direction of rotation about the axis of rotation of the main rubber body.

The elastic coupling of the present invention is further arranged such that there exists the rubber layer between the inner circumferential surface of each of the first and second through-holes of the main rubber body and the corresponding envelope portion of the reinforcing member. When the adjacent envelope portions partially surrounding the adjacent first and second through-holes are forced by the fixing members to be displaced relative to each other in the circumferential direction of the above-indicated circle, the corresponding rubber layers are subject to elastic deformation, so that the amounts of force to be exerted from the fixing members to the envelope portions are reduced by the elastic deformation of the rubber layers, whereby the amount of relative displacement of the adjacent envelope portions is reduced by the amount of reduction of the elastic deformation of the rubber layers. Accordingly, the local stress concentration at the corresponding spring portions due to the relative displacement of the adjacent envelope portions is alleviated, making it possible to prevent damaging of the spring portions due to the local stress concentration. Thus, the provision of the rubber layers is effective to prolong the expected service life of the reinforcing member, and increase the durability of the elastic coupling.

The elastic coupling of the present invention is comparatively easy and economical to manufacture, owing to the simple structure and accordingly easy manufacture of the reinforcing member, while assuring a high degree of consistency in the torsional stiffness with respect to the load applied thereto in the direction of rotation of the main rubber body about its axis, and a considerably long service life of the reinforcing member, which results in accordingly increased durability of the elastic coupling.

In the present elastic coupling wherein the rubber layers existing between the inner circumferential surfaces of the first and second through-holes and the corresponding envelope portions of the reinforcing member are elastically deformable upon relative displacement of the adjacent envelope portions due to relative displacement of the first and second fixing members in the plane perpendicular to the axis of rotation of the main rubber body, vibrations of a relatively small amplitude which take place between the two rotary shaft members can be effectively damped or absorbed by a damping or cushioning effect based on the elastic deformation of the rubber layers, so that the two rotary shaft members can be elastically or flexibly connected to each other by the present elastic coupling, with enhanced vibration damping characteristics.

In a first preferred form of the elastic coupling of the invention, the plurality of envelope portions consist of a plurality of convex portions including respective substantially semicircular parts located radially outwardly of the above-indicated circle, while the plurality of spring portions consist of a plurality of concave portions including respective intermediate parts located radially inwardly of the above-indicated circle, the convex and concave portions being alternately arranged along the circle.

In the elastic coupling according to the first preferred form of the invention wherein the intermediate portion of each spring portion is located inside the above-indicated circle, the spring portion is able to generate a relatively large resilient force resisting a relative displacement of the adjacent two envelope portions when this relative displacement takes place due to a relative displacement of the two rotary shaft members. Accordingly, the torsional stiffness of the elastic coupling with respect to a load applied thereto in the rotating direction can be held stable at a sufficiently high nominal value.

In the above form of the elastic coupling, the resilient forces to be generated by the spring portions of the reinforcing member can be easily adjusted as needed by changing the radius of curvature at their intermediate parts.

According to a first advantageous arrangement of the above-indicated first preferred form of the elastic coupling, each of the plurality of spring portions further includes a pair of connecting arms which are located on respective opposite sides of the intermediate part and which terminate in the respective two adjacent envelope portions, and the pair of connecting arms are formed such that lines of extension of the pair of connecting arms intersect each other at an acute angle.

In the first advantageous arrangement of the first preferred form of the elastic coupling, the pair of connecting arms have a larger length than a pair of arms which are formed such that their lines of extensions intersect each other at right angles or at an obtuse angle. This arrangement is effective to prevent damaging of the spring portions due to local stress concentration upon relative displacement of the two adjacent envelope portions. Accordingly, the service life of the reinforcing member is prolonged, and the durability of the elastic coupling is accordingly increased.

According to a second advantageous arrangement of the above-indicated first preferred form of the elastic coupling of the invention, the reinforcing member consists of a plurality of loops which are formed of the single wire of the spring steel and which are superposed on each other, each of the plurality of loops including the plurality of concave portions provided as the plurality of spring portions, the intermediate parts of the concave portions of at least one but not all of the plurality of loops have a radius of curvature larger than that of the intermediate parts of the concave portions of the other of the plurality of loops.

In the above second advantageous arrangement, the spring portions of at least one of the loops wherein the intermediate parts of the concave portions have the larger radius of curvature exhibit a comparatively high spring stiffness, that is, a comparatively hard spring characteristic, while the spring portions of the other loop or loops wherein the intermediate parts have the smaller radius of curvature exhibit a comparatively low spring stiffness, that is, a comparatively soft spring characteristic. Accordingly, the elastic coupling according to the second advantageous arrangement indicated above exhibits a comparatively soft spring characteristic when the angle of torsion of the main rubber body is relatively small, and a comparatively hard spring characteristic when the angle of torsion is relatively large.

Therefore, the elastic coupling according to the second advantageous arrangement is suitably usable as a steering coupling on an automotive vehicle, and any other elastic coupling which is required to exhibit a soft spring characteristic to effectively damp torsional vibrations of a relatively small amplitude caused by a periodic relative displacement of the input and output rotary shaft members by a relative small angle in the rotating direction of the main rubber body, and a hard spring characteristic when the angle of torsion of the main rubber body is comparatively large, for instance, when one of two rotary shaft portions of a steering column is rotated by manipulation of a steering wheel by the vehicle operator.

In a second preferred form of the elastic coupling according to the invention, the reinforcing member consists of a plurality of loops which are respectively formed of a plurality of wires of a spring steel and which are superposed on each other, at least one but not all of the plurality of wires having a large diameter than the other of the plurality of wires.

In the above second preferred form of the elastic coupling of the invention, the spring portions of at least one of the loops, which are formed of the relatively thick wire or wires, exhibit a comparatively high spring stiffness, that is, a comparatively hard spring characteristic, while the spring portions of the other loop or loops, which are formed of the relatively thin wire or wires, exhibit a comparatively low spring stiffness, that is, a comparatively soft spring characteristic. Accordingly, the elastic coupling according to the second preferred form of the invention exhibits a comparatively soft spring characteristic when the angle of torsion of the main rubber body is relatively small, and a comparatively hard spring characteristic when the angle of torsion is relatively large. The elastic coupling according to this preferred form of the invention can be suitably used as a steering coupling provided in a steering system of an automotive vehicle.

In a third preferred form of the elastic coupling of the invention, the reinforcing member consists of a plurality of loops which are formed by respective turns of the single wire of the spring steel and which are superposed on each other, each of the plurality of loops including the plurality of envelope portions and the plurality of spring portions. This reinforcing member can be easily and economically manufactured, and can be easily handled during the manufacture of the elastic coupling, so that the elastic coupling is accordingly easy and economical to manufacture.

In a fourth preferred form of the elastic coupling of the invention, each of the rubber layers formed between the envelope portions of the reinforcing member and the circumferential portions of the first and second through-holes of the main rubber body has at least one cutout formed so as to extend substantially continuously between opposite surfaces of the main rubber body.

In the above fourth preferred form of the elastic coupling of the invention wherein the cutouts are formed through the rubber layers formed between the envelope portions and the inner circumferential surfaces of the first and second through-holes, a relative displacement of the adjacent envelope portions due to a relative displacement of the two rotary shaft members causes elastic deformation of the rubber layers in the form of compression between the envelope portions and the fixing members, and consequent displacement or shearing deformation of the opposite end portions of each rubber layer along the envelope portion, so as to reduce the volumes of the cutouts. Thus, the cutouts reduce the spring stiffness of the rubber layers, so that the elastic coupling provides an improved damping or cushioning effect based on the elastic deformation of the rubber layers, thereby effectively damping or absorbing vibrations of a relatively small amplitude which take place between the two rotary shaft members which are attached to the main rubber body through the first and second fixing members inserted through the first and second through-holes.

In a fifth preferred form of the elastic coupling of the present invention, the main rubber body has a plurality of openings which are open in at least one of opposite surfaces of the main rubber body and through which each of the plurality of envelope portions of the reinforcing member is partially exposed to the atmosphere, the main rubber body further having a plurality of annular protrusions formed on each of the above-indicated at least one of opposite surfaces thereof, each of the annular protrusions surrounding the plurality of openings for the corresponding one of the envelope portions.

In the elastic coupling according to the above fifth preferred form of the invention, the openings are formed in the main rubber body, as a result of removal of support members from the main rubber body which has been formed by vulcanization of a rubber material in a mold cavity in which the reinforcing member is positioned in place by the support members, so that the reinforcing member is embedded within the formed main rubber body. The main rubber body further has an annular protrusion formed on at least one of the opposite surfaces thereof in which the openings for each envelope portion are open. The annular protrusion is positioned so as to surround all of the openings for the corresponding envelope portion. When the two rotary shaft members are flexibly attached to the present elastic coupling, the first and second fixing members are inserted into the respective first and second through-holes, with washers held in contact with the annular protrusions formed so as to surround the openings through which each envelope portion is exposed to the atmosphere. Then, a nut is screwed on an externally threaded end portion of each fixing members. By tightening the nuts on the fixing members, the washers are forced onto the annular protrusions, whereby the annular protrusions are collapsed with elastic deformation, and the openings are closed by the washers in pressing contact with the collapsed annular protrusions. Thus, the two rotary shaft members are elastically connected to each other through the present elastic coupling.

In the elastic coupling according to the fifth preferred form of the invention wherein the main rubber body has the annular protrusions surrounding the openings formed as a result of removal of the support members used to support the reinforcing member in the mold cavity, a relative axial displacement of the two rotary shaft members away from each other does not cause the washers to be spaced apart from the annular protrusions, since the relative axial displacement of the two rotary shaft members causes the collapsed annular protrusions to be expanded toward the original state. This arrangement is effective to prevent entry of foreign matters such as water into the annular protrusions through gaps which would be generated between the washers and the annular protrusions if the washers were spaced apart from the annular protrusions upon the relative axial displacement of the two rotary shaft members.

Accordingly, the provision of the annular protrusions in the elastic coupling according to the fifth preferred form of the invention effectively prevents local corrosion of the envelope portions due to contact with foreign matters such as water, which would enter into the openings if the annular protrusions and the washers were separated from each other when the two rotary shaft members are axially displaced away from each other. Accordingly, the annular protrusions function to prolong the service life of the reinforcing member, and accordingly increase the durability of the elastic coupling as a whole.

In a sixth preferred form of the elastic coupling of the invention, the main rubber body has a plurality of openings which are open in at least one of opposite surfaces of the main rubber body and through which each of the plurality of envelope portions of the reinforcing member is partially exposed to the atmosphere, the main rubber body further having a plurality of annular protrusions formed on each of the above-indicated at least one of opposite surfaces thereof, the plurality of annular protrusions respectively surrounding said plurality of openings of the plurality of envelope portions.

The two rotary shaft members can be attached to the elastic coupling according to the above sixth preferred form of the invention, by tightening the nuts on the first and second fixing members inserted through the first and second through-holes, in the same manner as described above with respect to the fifth preferred form of the invention, except in that one washer is held in contact with the plurality of annular protrusions provided for the respective openings through which each envelope portion is exposed to the atmosphere. Thus, the provision of the annular protrusions in the elastic coupling according to the sixth preferred form of the invention is also effective to prevent local corrosion of the envelope portions due to contact with foreign matters such as water, which would enter into the openings if the annular protrusions and the washers were separated from each other when the two rotary shaft members are axially displaced away from each other.

The annular protrusions provided according to the sixth preferred form of the invention also function to prolong the service life of the reinforcing member, and accordingly increase the durability of the elastic coupling as a whole.

### BRIEF DESCRIPTION OF THE DRAWINGS

The above and other objects, features, advantages and technical and industrial significance of the present invention will be better understood by reading the following detailed description of a presently preferred embodiment of the invention, when considered in connection with the accompanying drawings, in which:

FIG. 1 is a front elevational view of an elastic coupling constructed according to a first embodiment of this invention;

FIG. 2 is a cross sectional view taken along line 2-2 of FIG. 1;

FIG. 3 is a perspective view of a reinforcing member embedded within a main rubber body of the elastic coupling of FIG. 1:

FIG. 4 is a fragmentary enlarged view in cross section taken along line 4-4 of FIG. 2:

FIG. 5 is a fragmentary view in cross section taken along line 5-5 of FIG. 1;

FIG. 6 is a graph indicating a relationship between a torsional torque and an angle of torsion of the elastic coupling of FIG. 1:

FIG. 7 is a view corresponding to that of FIG. 1, showing an elastic coupling constructed according to a second embodiment of the invention;

FIG. 8 is a view corresponding to that of FIG. 1, showing an elastic coupling constructed according to a third embodiment of this invention;

FIG. 9 is a fragmentary view in cross sectional taken along line 9-9 of FIG. 8; and

FIG. 10 is a fragmentary view in cross section taken along line 10-10 of FIG. 8.

### DETAILED DESCRIPTION OF THE PREFERRED EMBODIMENTS

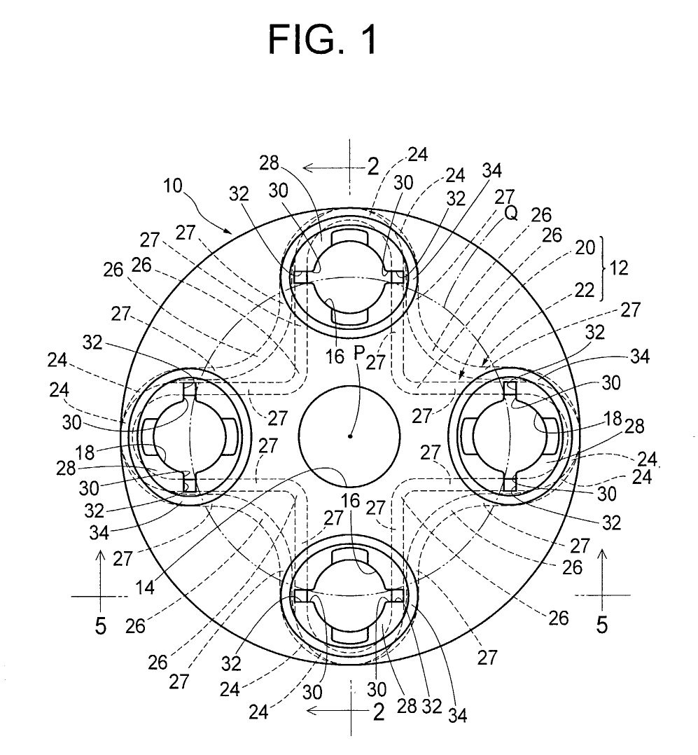

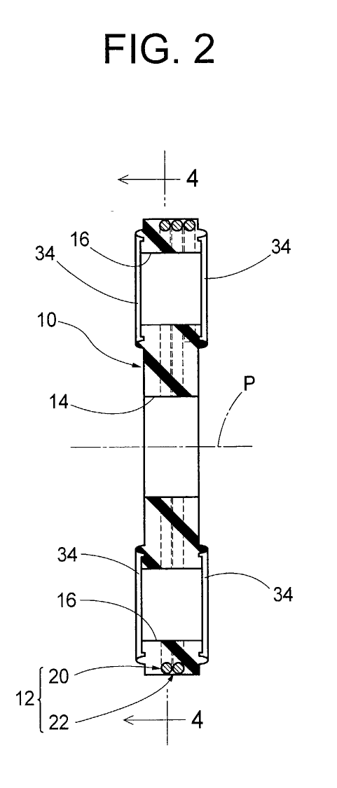

Referring to FIGS. 1-6, there will be described an elastic coupling in the form of a steering coupling constructed according to the first embodiment of the present invention. The steering coupling is used on an automotive vehicle, to elastically or flexibly connect two rotary shaft members in the form of two rotary shaft portions of a steering column or post (not shown). One of the two rotary shaft portions is on the side of the steering gear of a steering system of the vehicle, while the other rotary shaft portion is on the side of a manually operable steering wheel of the steering system. As schematically shown in the front elevational view of FIG. 1 and the cross sectional view of FIG. 2, the present steering coupling includes a generally planar main rubber body in the form of an elastic plate 10, and a reinforcing member 12 embedded within a mass of a rubber material of the elastic plate 10.

The steering coupling includes a generally planar main rubber body in the for of an elastic plate 10, which takes the form of a generally circular disc having a relatively large thickness and a cylindrical center hole 14 formed through its thickness in its radially central portion. The elastic plate 10 has two first through-holes 16 and two second through-holes 18 formed in a relatively outer portion thereof, such that the through-holes 16 and through-holes 18 are alternately arranged equiangularly, namely, at an angular spacing interval of 90°, along a circle Q (FIG. 1) having a center on the axis of rotation P (FIGS. 1 and 2) of the elastic plate 10. The two first through-holes 16 are spaced apart from each other in a first diametric direction, while the two second through-holes 18 are spaced apart from each other in a second diametric direction perpendicular to the first diametric direction. The four through-holes 16, 18 have their centers which lie on respective four apexes of a square which is inscribed with respect to the circle Q. The four through-holes 16, 18 have substantially cylindrical inner surfaces having the same diameter, which is smaller than that of the center hole 14, and are formed with their centerlines being parallel to the rotation axis P of the elastic plate 10.

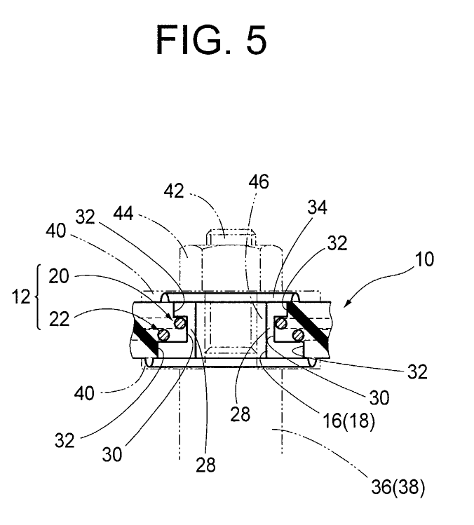

As indicated above, the present steering coupling is interposed between mutually opposed ends of first and second rotary shaft members in the form of the two rotary shaft portions of the steering column, which are on the side of the steering wheel and the steering gear, respectively. One of the two rotary shaft portions is provided at the above-indicated end with two first fixing members 36 (FIG. 5) each having externally threaded end portion, while the other rotary shaft portion is provided with the corresponding end with two second fixing members 38 (FIG. 5) each having externally threaded end portion. As described below in detail by reference to FIG. 5, the two first fixing members 36 are inserted through the respective two first through-holes 16 in one axial direction of the elastic plate 10, while the two second fixing members 38 are inserted through the respective two second through-holes 18 in the opposite axial direction, so that the two shaft portions of the steering column are elastically or flexibly connected to each other by the present steering coupling such that the steering coupling is rotatable about the axis P together with the steering column (two shaft portions), whereby a rotary motion or torque can be transmitted from the steering column (steering wheel) to the steering gear, while the transmission of a vibration between the two shaft portions is minimized or prevented by elastic deformation of the elastic plate 10, as well known in the art.

In the present steering coupling, the reinforcing member 12 embedded within the elastic plate 10 is uniquely constructed to provide advantages not offered by the reinforcing member used in the known elastic coupling, as described below in detail.

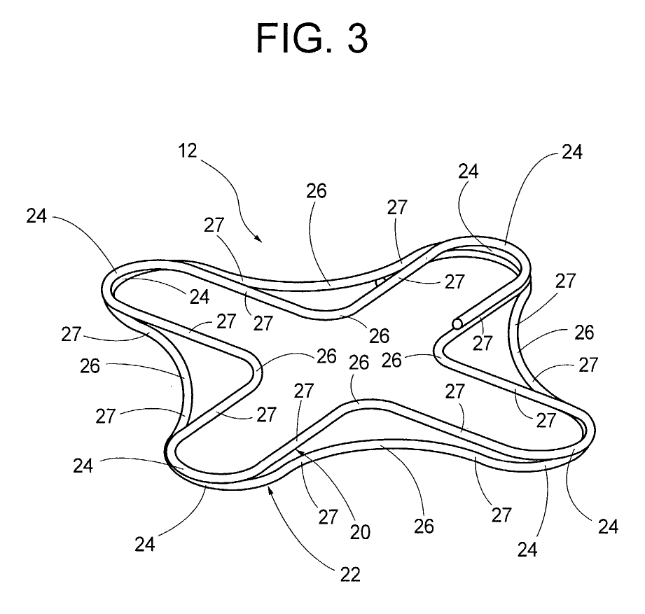

As shown in FIGS. 1 and 3, the reinforcing member 12 is formed of a single wire of a spring steel such as a carbon steel or alloyed steel having a suitably selected constant diameter over its entire length. That is, the spring steel wire is bent to form a wirework structure having an upper asteroidal loop 20 and a lower asteroidal loop 22 which are superposed on each other in contact with each other, as shown in FIG. 3. The upper asteroidal loop 20 has a crisscross shape, while the lower asteroidal loop 22 has a quasi-crisscross shape. Each of these loops 20, 22 has four apexes and is symmetrical with respect to its center.

Each of the upper and lower asteroidal loops 20, 22 has four convex envelope portions 24 corresponding to the four apexes indicated above. Each of the four convex envelope portion 24 has a substantially semicircular part surrounding a part of the corresponding through-hole 16, 18, which part is located radially outwardly of the other part as seen in the radial direction of the circular elastic plate 10. Each asteroidal loop 20, 22 further has four concave spring portions 26 each of which is curved inwardly of the envelope portions 24, so as to connect the adjacent envelope portions 24. Each of the four concave spring portions 26 has opposite end parts in the form of a pair of connecting arms 27 which terminate in the respective two adjacent envelope portions 24. The concave spring portions 26 are curved inwardly of the reinforcing member 12, such that lines of extension of the two connecting arms 27 intersect each other substantially at right angles.

In other words, the reinforcing member 12 used in the present steering coupling is an integral wirework structure consisting of the upper and lower asteroidal loops 20, 22 of the single spring steel wire, each asteroidal loop including the four outwardly curved convex envelope portions 24 and the four inwardly curved concave spring portions 26. The envelope portions 24 and the spring portions 26 are alternately arranged along the loop 20, 22, such that the adjacent two envelope portions 24 are connected to each other by the spring portion 26 located therebetween, and such that the four envelope portions 24 are spaced from each other at an angular spacing interval of 90° in the rotating direction of the elastic plate 10, while the four spring portions 26 are also spaced from each other at the angular spacing interval of 90°. In this arrangement of the reinforcing member 12, each of the spring portion 26 generates a resilient force to resist a relative displacement of the adjacent two envelope portions 24 toward or away from each other, which would take place due to a torsional load applied to the reinforcing member 12 in the rotating direction through the two rotary shaft portions of the steering column (through the first and second sets of fixing members 36, 38).

The upper and lower asteroidal loops 20, 22 of the reinforcing member 12 are dimensioned so as to be able to surround or located outwardly of all of the first and second through-holes 16, 18 in the radial direction of the circular elastic plate 10. The substantially semicircular parts of the envelope portions 24 of each asteroidal loop 20, 22 have an inside diameter larger than the diameter of the first and second through-holes 16, 18. When the reinforcing member 12 is embedded in place in the elastic plate 10, the substantially semicircular parts of the envelope portions 24 of the two asteroidal loops 20, 22 are located radially outwardly of the circle Q, and the envelope portions 24 with the substantially semicircular parts surround the respective through-holes 16, 18 over more than a half of their circumference. Further, the spring portions 26 of the two asteroidal loops 20, 22 are located radially inwardly of the circle Q.

In the reinforcing member 12, an intermediate part of each spring portion 26 of the lower asteroidal loop 22 has a larger radius of curvature than that of the upper asteroidal loop 20, so that the spring portions 26 of the lower asteroidal loop 22 are generally located radially outwardly of the spring portions 26 of the upper asteroidal loop 20. In this arrangement, the spring portions 26 of the lower asteroidal loop 22 generate a larger resilient force than those of the upper asteroidal loop 20.

The reinforcing member 12 constructed as described above is embedded within the elastic plate 10, as shown in FIGS. 1 and 2, such that the envelope portions 24 of the upper and lower asteroidal loops 20, 22 surround the respective through-holes 16, 18 over more than a half of their circumference, at the circumferential portions of the through-holes 16, 18 outside the circle Q, with a predetermined spacing to those circumferential portions, while the spring portions 26 of the loops 20, 22 are located inside the circle Q.

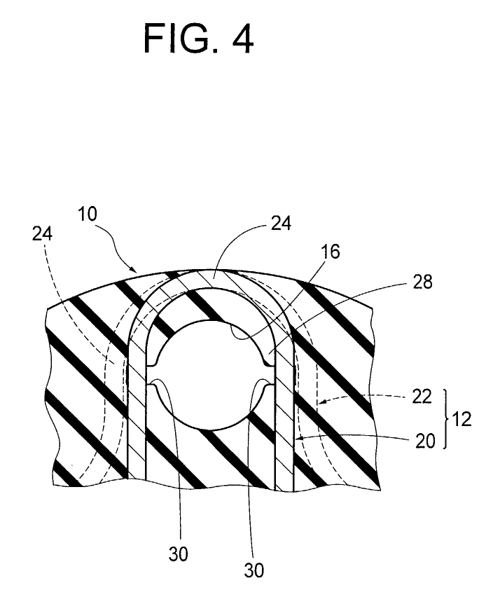

With the reinforcing member 12 embedded in the elastic plate 10, there exists a rubber layer 28 having a suitable thickness between the semicircular part of each envelope portion 24 of each asteroidal loop 20, 22 and the corresponding circumferential portion of the corresponding first or second through-hole 16, 18, as shown in FIGS. 4 and 5. In other words, the rubber layer 28 formed along the substantially semicircular part of the envelop portion 24 partially defines the corresponding through-hole 16, 18.

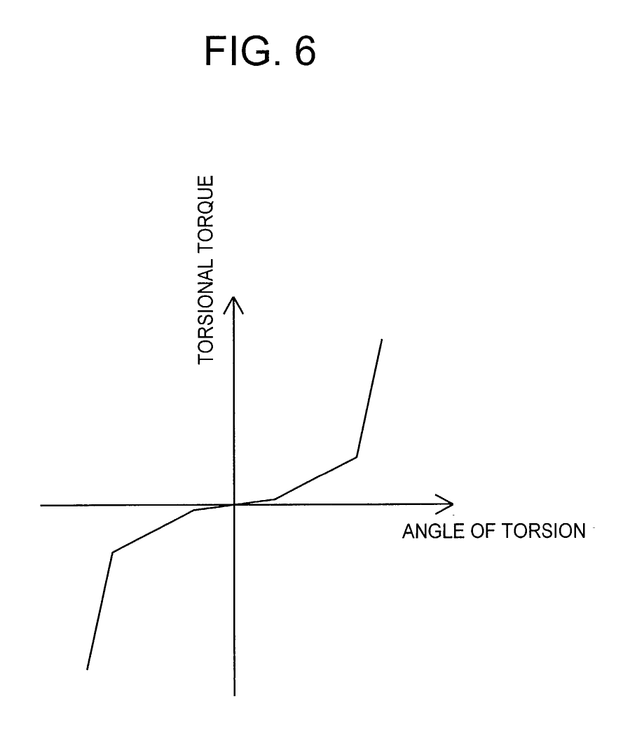

In the present steering coupling, the spring portions 26 of the upper asteroidal loop 20 and the spring portions 26 of the lower asteroidal loop 22 having a large radius of curvature exhibit different spring characteristics. Further, the rubber layers 28 formed between the envelope portions 24 and the through-holes 16, 18 cooperate with the spring portions 26 of the two asteroidal loops 20, 22, to permit the present steering coupling to exhibit different spring characteristics depending upon an angle of torsion of the steering coupling, as indicated in the graph of FIG. 6, which schematically shows a relationship between the angle of torsion and a torsional torque applied to the steering coupling. Described more specifically by reference to the graph, the steering coupling exhibits: a very soft spring characteristic based on the elasticity of the rubber layers 28 when the angle of torsion is smaller than a first threshold value; a relatively soft spring characteristic based on the spring portions 26 of the upper asteroidal loop 20 when the angle of torsion is between the first threshold value and a second threshold value larger than the first threshold value; and a relatively hard spring characteristic based on the spring portions 26 of the lower asteroidal loop 22 when the angle of torsion is larger than the second threshold value. Thus, the present steering coupling is capable of exhibiting spring characteristics not obtained by the prior art elastic couplings.

The opposite ends of each rubber layer 28 formed along the substantially semicircular part of each envelope portion 24 of each asteroidal loop 20, 22 are defined by respective two cutouts 30 which are formed through the thickness of the elastic plate 10 and open in the corresponding through-hole 16, 18. These two cutouts 30 are located close to the respective opposite ends of the substantially semicircular part of the envelope portion 24 and the respective two connecting arms 27 of the adjacent spring portions 26 adjacent to the envelope portion 24 in question. The cutouts 30 facilitate elastic deformation of the rubber layer 28, more precisely, permit elastic deformation of the rubber layer 28 in the form of compression between the envelope portion 24 and the fixing member 36, 38 and consequent displacement or shearing deformation of the opposite end portions of the rubber layer 28 to some extent, along the envelope portion 24, so as to reduce the volumes of the cutouts 30, resulting in a relatively soft spring characteristic of the rubber layer 28.

An intermediate portion of the bottom of each cutout 30, which is intermediate as viewed in the direction of thickness of the elastic plate 10, is defined by the two asteroidal loops 20, 22, as shown in FIG. 4. However, the intermediate portion of the bottom of each cutout 30 may be defined by a thin rubber layer which may be inevitably formed together with the rubber layer 28, due to a restriction in the manufacture of the elastic plate 10 with the reinforcing member 12. However, the thickness of this thin rubber layer is not so large as to deteriorate the function of the cutout 30.

Further, the elastic plate 10 has two openings 32 for each of the four envelope portions 24 of each asteroidal loop 20, 22, as shown in FIGS. 1 and 5. The two openings 32 for each envelope portion 24 of the upper asteroidal loop 20 are open in the upper surface of the elastic plate 10 while the two openings 32 for each envelope portion 24 of the lower asteroidal loop 22 are open in the lower surface of the elastic plate 10. Each envelope portion 24 is partially exposed to the atmosphere through the corresponding two openings 32. These openings 32 are formed by respective support pins used to support the reinforcing member 12 in a mold cavity used to mold the present steering coupling such that the reinforcing member 12 is embedded within the elastic plate 10, as described above. After the elastic plate 10 is formed by vulcanization of a suitable rubber material, the support pins are removed from the elastic plate 10, so that the openings 32 are formed.

The elastic plate 10 further has four annular protrusions 34 formed on each of its upper and lower surfaces, such that the four annular protrusions 34 on each surface correspond to the respective four through-holes 16, 18 and such that each annular protrusion 34 is concentric with the corresponding through-holes 16, 18. The diameter of the annular protrusions 34 is determined so that the two openings 32 for each envelope portion 24 are located within the corresponding annular protrusion 34. Each annular protrusion 34 has a circumferential wall having a relatively small thickness and a convex end face.

As indicated above, the present steering coupling is used to elastically connect the two rotary shaft portions of the steering column or post such that the first fixing members 36 (indicated by two-dot chain line in FIG. 5) fixed to the end of the rotary shaft portion on the side of the steering wheel are inserted through the respective two first through-holes 16 in a first axial direction of the elastic plate 10, while the second fixing members 38 (also indicated by two-dot chain line in FIG. 5) are inserted through the respective two second through-holes 18 in a second axial direction opposite to the first axial direction. Each of the first and second fixing members 36, 38 has an externally threaded end portion 42 which cooperates with the other portion of the fixing member to define a shoulder surface. When the fixing member 36, 38 is attached to the steering coupling, a washer 40 is mounted on the fixing member 36, 38 in contact with the above-indicated shoulder surface, and the threaded end portion 42 is inserted into the appropriate through-hole 16, 18 until the washer 40 comes into contact with one of the two annular protrusions 34 provided for the through-hole 16, 18 in question. Then, another nut 40 is fitted on the threaded end portion 42, and a nut 44 is screwed on the threaded end portion 42. By tightening the nut 44, the two washers 40 are forced onto the respective two annular protrusions 34, whereby the annular protrusions 34 are collapsed with elastic deformation, and the openings 32 are closed by the washers 40 in pressing contact with the collapsed annular protrusions 34. Thus, the two rotary shaft members in the form of the two shaft portions of the steering column of the vehicle are elastically or flexibly connected to each other by the elastic coupling in the form of the steering coupling including the generally planar main rubber body in the form of the elastic plate 10 and the reinforcing member 12 in the form of the wirework structure formed of a single spring steel wire and embedded in the elastic plate 10. With the two shaft portions of the steering column elastically connected by the steering coupling interposed therebetween, the steering coupling is rotatable together with the steering column, namely, with the two rotary shaft portions.

When the elastic plate 10 is elastically deformed due to a relative axial displacement of the two rotary shaft portions of the steering column for some reason or other, the two washers 40 are held in pressing contact with the annular protrusions 34, owing to the elasticity of the annular protrusions 34, thereby preventing entry of foreign substances such as water into the openings 32 through gaps which would be created between the washers 40 and the annular protrusions 34 if the washers 40 were spaced apart from the annular protrusions 34. In FIG. 5, reference numeral 46 denotes a collar interposed between the threaded end portion 42 of the fixing member 36, 38 and the inner circumferential surface of the through-hole 16, 18. The washers 40 may be replaced by outwardly extending flanges formed at the opposite axial ends of the collar 46. In this case, the flanges of the collar 46 are held in pressing contact with the annular protrusions 34 by tightening the nut 44 on the externally threaded end portion 42.

In the steering coupling according to the present first embodiment constructed as described above, the reinforcing member 12 is embedded in the elastic plate 10 such that each of the envelope portions 24 of each of the upper and lower asteroidal loops 20, 22 of the reinforcing member 12 surrounds a circumferential portion of the corresponding through-hole 16, 18 which is located radially outwardly of the circle Q and which corresponds to more than a half of the circumference of the through-hole 16, 18. Further, the reinforcing member 12 is positioned relative to the elastic plate 10 such that each of the spring portions 26 of each asteroidal loop 20, 22 is located radially inwardly of the circle Q. When the two rotary shaft portions of the steering column are displaced in the radial direction relative to each other at their ends at which the rotary shaft portions are flexibly attached to the steering coupling with the first and second fixing members 36, 38 fixedly inserted through the respective first and second through-holes 16, 18, the adjacent envelope portions 24 partially surrounding the adjacent first and second through-holes 16 and 18 are forced by the fixing members 36, 38 to be displaced relative to each other in the circumferential direction of the circle Q. At this time, the spring portions 26 generate resilient forces resisting the relative displacement of the adjacent envelope portions 24, thereby minimizing an amount of torsional deformation of the elastic plate 10 due to the relative displacement of the two rotary shaft portions of the steering column in a plane perpendicular to the rotation axis P of the elastic plate 10. Thus, the reinforcing member 12 functions to increase the torsional stiffness of the elastic plate 10 with respect to a torsional load applied thereto in its direction of rotation about its axis P.

Further, the reinforcing member 12 embedded within the elastic plate 10 is an integral wirework structure consisting of the upper and lower asteroidal loops 20, 22 formed by respective two turns of a single wire of a spring steel. This wirework structure can be formed more easily than the conventionally used reinforcing member consisting of a coil of a synthetic resin cord, which is formed by winding the cord a large number of times. In addition, the wirework structure formed of the spring steel wire does not suffer from the drawbacks experienced by the conventional reinforcing member, such as a variation in its configuration, thermal contraction during vulcanization of the elastic plate 10, and dislocation with respect to the through-holes 16, 18 due to the vulcanization pressure. Accordingly, the elastic coupling including the reinforcing member 12 embedded within the elastic plate 10 is held consistent in its torsional stiffness or its spring characteristic in the direction of rotation about the axis P.

Thus, the steering coupling according to the present embodiment is comparatively easy and economical to manufacture, while assuring a high degree of consistency in the torsional stiffness at the nominal value.

The steering coupling of the present embodiment is further arranged such that there exists the rubber layer 28 between the inner circumferential surface of each of the first and second through-holes 16, 18 of the elastic plate 10 and the corresponding envelope portion 24 of each asteroidal loop 20, 22 of the reinforcing member 12. When the adjacent envelope portions 24 partially surrounding the adjacent first and second through-holes 16 and 18 are forced by the fixing members 36, 38 to be displaced relative to each other in the circumferential direction of the circle Q, the corresponding rubber layers 28 are subject to elastic deformation, so that the amounts of force to be exerted from the fixing members 36, 38 to the envelope portions 24 are reduced by the elastic deformation of the rubber layers 28, whereby the amount of relative displacement of the adjacent envelope portions 24 is accordingly reduced. Accordingly, the local stress concentration at the corresponding spring portions 26 due to the relative displacement of the adjacent envelope portions 24 is alleviated, making it possible to prevent damaging of the spring portions 24 due to the local stress concentration. Thus, the provision of the rubber layers 28 is effective to prolong the expected service life of the reinforcing member 12, and increase the durability of the steering coupling.

Further, the elastic deformation of the rubber layers 28 provides a vibration damping effect or a cushioning effect to effectively reduce the amount of transmission of vibrations of a relatively small amplitude between the two rotary shaft portions of the steering column.

In the present steering coupling, each of the upper and lower asteroidal loops 20, 22 of the reinforcing member 12 has a generally crisscross configuration having the four convex envelope portions 24 and the four concave spring portion 26 which are alternately arranged in the circumferential direction of the circle G along which the first and second through-holes 16, 18 are arranged. With this reinforcing member 12 embedded in the elastic plate 10, the intermediate portion of each spring portion 26 is located inside the circle Q, so that each spring portion 26 is able to generate a relatively large resilient force resisting a relative displacement of the adjacent two envelope portions 24, for thereby assuring a high degree of stability of the torsional stiffness of the steering coupling with respect to the load applied thereto in the direction of rotation about the axis P.

In the present steering coupling, the radius of curvature of the spring portions 26 of the lower asteroidal loop 22 is made larger than that of the spring portions 26 of the upper asteroidal loop 20, so that the spring portions 26 of the lower asteroidal loop 22 are able to generate larger resilient forces than those of the upper asteroidal loop 20. That is, the spring portions 26 of the lower asteroidal loop 22 have a comparatively high stiffness or a comparatively hard spring characteristic, while the spring portions 26 of the upper asteroidal loop 20 have a comparatively low stiffness or a comparatively soft spring characteristic. Accordingly, the present steering coupling exhibits a relatively soft spring characteristic when the angle of torsion of the elastic plate 10 is relatively small, and a relatively hard spring characteristic when the angle of torsion is relatively large, as described above.

In the present steering coupling therefore, a torsional vibration caused by a periodic relative displacement of the two rotary shaft portions of the steering column in the rotating direction of the elastic plate 10 by a comparatively small angle can be effectively damped based on the relatively soft spring characteristic of the spring portions 26 of the upper asteroidal loop 20. When the angle of torsion of the elastic plate 10 is comparatively large, for instance, when one of the rotary shaft portions is rotated by manipulation of the steering wheel by the vehicle operator, the steering coupling exhibits a comparatively hard spring characteristic based on the comparatively hard spring stiffness of the spring portions 26 of the lower asteroidal loop 22, so that the response of the steering system to the manipulation of the steering wheel, as felt by the vehicle operator, is significantly improved.

Further, the use of the single wire of spring steel to form the integral wirework consisting of the upper and lower asteroidal loops 20, 22 of the reinforcing member 10 permits easier manufacture of the reinforcing member 12, that the use of two spring steel wires to form the respective two separate asteroidal loops superposed on each other. Further, the integral wirework consisting of the upper and lower asteroidal loops 20, 22 is easier to handle when the elastic plate 10 is formed by vulcanization of the rubber material in a mold cavity, such that the reinforcing member 12 is embedded within a mass of the rubber material of the elastic plate 10.

The steering coupling of the present embodiment is further arranged such that each of the rubber layers 28 formed between the envelope portions 24of the reinforcing member 12 and the circumferential portions of the inner circumferential surfaces of the first and second through-holes 16, 18 of the elastic plate 10 has the two cutouts 30 which are formed so as to extend continuously between the opposite surfaces of the elastic plate 10. These cutouts 30 reduce the spring stiffness of the rubber layers 28, so that the steering coupling provides an improved damping or cushioning effect based on the elastic deformation of the rubber layers 28, thereby effectively damping or absorbing vibrations of a relatively small amplitude which take place between the two rotary shaft portions of the steering column which are attached to the elastic plate 10 through the first and second fixing members 36, 38 inserted through the first and second through-holes 16, 18.

The present steering coupling is further arranged such that the annular protrusion 34 is formed on the opposite surfaces of the elastic plate 10, so as to surround the plurality of openings 32 through which each of the envelope portions 24 is partially exposed to the atmosphere through the opposite surfaces of the elastic plate 10. The provision of the annular protrusions 34 is effective to prevent entry of foreign matters such as water into the openings 32 while the two shaft portions of the steering column or post are elastically or flexibly connected at their end portions to each other through the present steering coupling through the first and second fixing members 36, 38 fixed to the above-indicated end portions of the shaft portions. Accordingly, the annular protrusions 34 effectively function to prevent local corrosion of the envelope portions 24 due to contact with the foreign matters, and therefore function to increase the service life of the reinforcing member 12 and accordingly increase the durability of the steering coupling as a whole.

While the preferred embodiment of the invention has been described above in detail, for illustrative purpose only, it is to be understood that the invention is not limited to the details of this illustrated embodiment, but may be otherwise embodied.

In the first embodiment, the reinforcing member 12 is a wirework structure consisting of the upper and lower asteroidal loops 20, 22, which are formed by respective two turns of a single wire of a spring steel, by bending the wire. However, the wirework structure of the reinforcing member 12 may consist of a single wire loop or a three or more wire loops which are superposed on each other. The number of the wire loops is suitably determined depending upon the thickness of the generally planar main rubber body in the form of the elastic plate 1, and required spring characteristics and other factors of the elastic coupling.

The reinforcing member may consist of a plurality of wire loops which are formed by bending respective separate wires of spring steel.

The wire loops of the reinforcing member are not limited to asteroidal loops such as the asteroidal loops 20, 22, but may take any other configurations depending upon the number and positions of the first and second through-holes formed through the generally planar main rubber body, provided the wirework structure of the reinforcing member includes: a plurality of envelope portions surrounding circumferential portions of the respective first and second through-holes, which circumferential portions are located radially outwardly of the above-indicated circle G and correspond to at least a half of the circumference of each through-hole, the envelope portions being spaced apart from the circumferential surfaces of the respective first and second through-holes in the radial direction of each through-hole, and a plurality of spring portions each of which connects the adjacent ones of the circumferential direction of the circle G, and generates a resilient force resisting a relative displacement of the adjacent envelope portions which takes place in the circumferential direction of the circle G.

For example, the reinforcing member consists of only one of the upper and lower asteroidal loops 20 and 22, or a single wire loop of any other configuration. Alternatively, the reinforcing member consists of a plurality of wire loops all which have the same configuration as the upper or lower asteroidal loop 20, 22, or any other configuration. Further, the reinforcing member may consist of a plurality of wire loops which have respective different configurations. Further alternatively, the reinforcing member consists of a plurality of wire loops some of which have the same configuration and the other of which have any other configuration or configurations.

The spring steel used to form the wirework of the reinforcing member may have any desired composition.

In the first embodiment, the upper and lower asteroidal loops 20 and 22 of the reinforcing member 12 are both formed by bending a single wire of spring steel having a suitable diameter. However, the upper and lower loops 20, 22 may be formed by bending two spring steel wires having respective different diameters. Where the reinforcing member consists of at least three loops, all of the loops may be formed by bending respective spring steel wires all of which have respective different diameters, or some of which have the same diameter.

Where the reinforcing member consists of a plurality of wire loops including two or more loops formed by bending spring steel wires of different diameters, the elastic coupling using this reinforcing member exhibits different spring characteristics corresponding to the different diameters of the spring steel wires. Namely, the elastic coupling exhibits a relatively soft spring characteristic when the angle of torsion of the main rubber body is relatively small, and a relatively hard spring characteristic when the angle of torsion is larger than a given threshold. This elastic coupling may be suitably used as a steering coupling for elastically connecting two rotary shaft portions of a steering column in a steering system of an automobile. For enabling the elastic coupling to exhibit desired torsional stiffness characteristics, and for obtaining a sufficient strength and a high degree of formability of the reinforcing member, the diameter of each spring steel wire used for the reinforcing member is preferably held within a range between about 0.4 mm and about 6 mm.

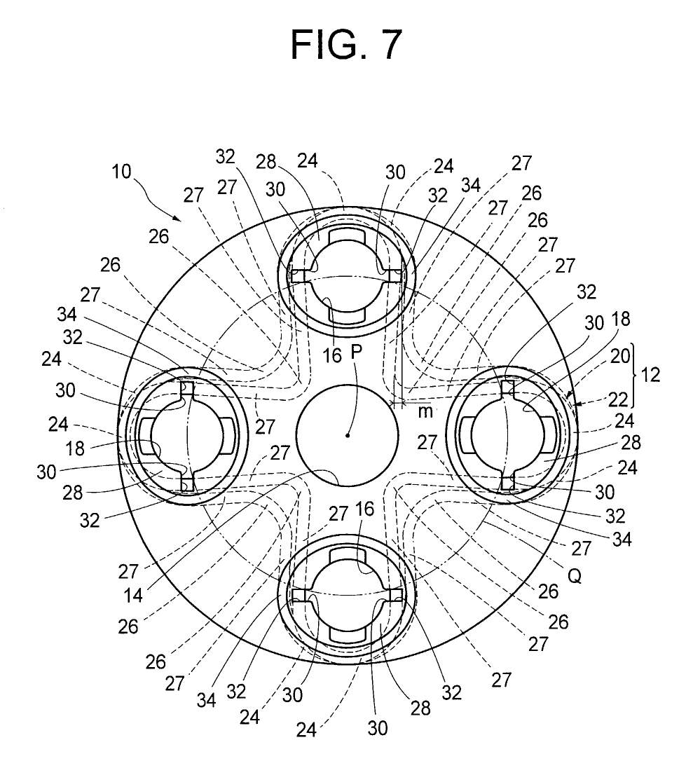

In the first embodiment, the lines of extension of the pair of arms 27 consisting of the opposite end parts of each spring portion 26 intersect each other substantially at right angles. However, each spring portion 26 may be formed such that the lines of extension of the pair of arms 27 intersect each other at an acute angle, as in a steering coupling constructed according to a second embodiment of this invention shown in FIG. 7. The intersection of the lines of extension of the arms 26 at an acute angle results in an increase in the length of the spring portion 26, which is effective to prevent damaging of the spring portion 26 due to local stress concentration upon a relative displacement of the adjacent two envelope portions 24 in the circumferential direction of the circle G. Accordingly, the reinforcing member 12 in the second embodiment of FIG. 7 has a prolonged service life, leading to an accordingly increased durability of the steering coupling.

The angle of intersection of the lines of extension of the two arms 27 in the second embodiment is not particularly limited, as long as the angle is smaller than 90°. In a steering coupling having a typical size, the angle of intersection of the lines of extension of the arms 26 is preferably determined such that a dimension “m” indicated in FIG. 7 is about 2 mm.

The shape, number and positions of the first and second through-holes 16, 18 formed through the plastic plate 10 are not particularly limited.

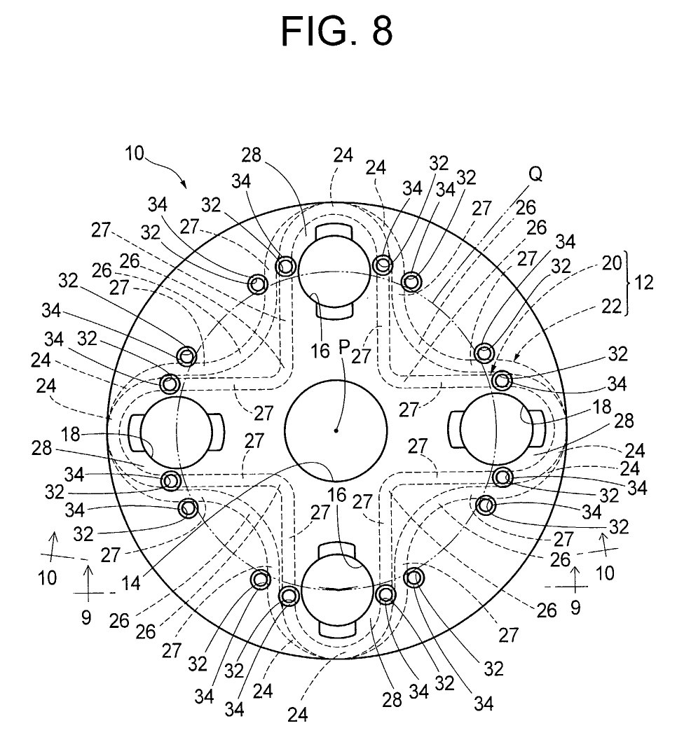

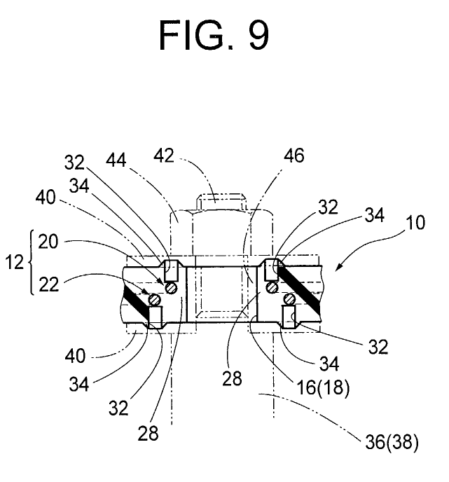

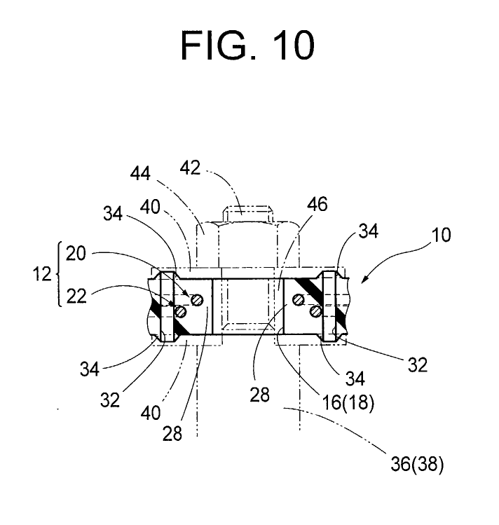

In the first and second embodiments, the two openings 32 are formed for each of the envelope portions 24 of each of the upper and lower asteroidal loops 20, 22, such that the two openings 32 are open in one of the opposite surfaces of the elastic plate 10 and such that each envelope portion 24 is exposed to the atmosphere through the two openings 32. As described above, these openings 32 are formed as a result of removing the respective support pins used to support the reinforcing member 12 in the mold cavity when the elastic plate 12 is formed in the mold cavity such that the reinforcing member 12 is embedded in the formed elastic plate 12. In the first and second embodiments, there are also formed the two annular protrusions 34 on the respective opposite surfaces of the elastic plate 10, for each of the envelope portions 24 partially surrounding the respective through-holes 16, 18. Each annular protrusion 34 is formed so as to surround the two openings 32 and the corresponding first or second through-hole 16, 18. In an elastic coupling according to a third embodiment shown in FIGS. 8-10, however, there are formed four openings 32 for each of the envelope portions 24 of each asteroidal loop 20, 22. In this arrangement, there are formed a total of eight openings 32 for each of the through-holes 16, 18, namely, four openings 32 open in one of the opposite surfaces of the elastic plate 10, and four openings 32 open in the other surface of the elastic plate 10, as shown in FIGS. 9 and 10. The two openings of the four openings 32 open in one of the opposite surfaces of the elastic plate 10 and the two openings of the four openings 32 open in the other surface communicate with each other, as shown in FIG. 10. Namely, the eight openings 32 for each through-hole 16, 18 are formed as a result of removing a total of six support pins used to support the reinforcing member 12 in the mold cavity, such that the four support pins are located to position the reinforcing member 12 in the axial direction of the elastic plate 10, while the remaining two support pins are located to position the reinforcing member 12 in the circumferential direction about the center of the reinforcing member 12. In the present third embodiment, four annular protrusions 34 are formed on each of the opposite surfaces of the elastic plate 10, for each of the through-hole 16, 18, such that the four annular protrusions 34 surround or enclose the respective four openings 32, as most clearly shown in FIG. 8.

In the third embodiment, too, the two washers 40 are fitted on the externally threaded end portion 42 of the fixing member 36, 38 and are placed on the respective opposite surfaces of the elastic plate 10, as indicated by two-dot chain lines in FIGS. 9 and 10. In the third embodiment, each of the washers 40 is held in pressing contact with all of the four annular protrusions 34, which are collapsed with elastic deformation by tightening the nut 44 on the threaded end portion 42. As a result, the openings 32 are closed by the washers 44 in pressing contact with the collapsed annular protrusions 34. Thus, the first and second fixing members 36, 38 are fixedly inserted through the respective first and second through-holes 16, 18, whereby the two rotary shaft portions of the steering column are elastically connected to each other through the steering coupling. As in the first and second embodiments, the annular protrusions 34 function to prevent entry of foreign matters such as water into the openings 32, which would take place if the washers 44 were spaced apart from the annular protrusions 34 due to a relative axial displacement of the first and second fixing members 36, 38 away from each other in the axial direction.

Accordingly, the annular protrusions 34 function to prevent corrosion of the envelope portions 34 of the reinforcing member 12 due to otherwise possible entry of water into the openings 32, leading to a prolonged service life of the reinforcing member 12 and an accordingly increased durability of the steering coupling as a whole.

While there have been several preferred embodiments of this invention as applied to the steering coupling for an automotive vehicle, it is to be understood that the principle of the present invention is equally applicable to any other types of elastic coupling for elastically connecting two rotary shaft members to each other, for instance, a propeller shaft coupling for elastically connecting two shaft portions of a propeller shaft.

It is to be understood that the present invention may be embodied with various other changes, modifications and improvements, which may occur to those skilled in the art, without departing from the spirit and scope of the invention defined in the following claims:

What is claimed is:

1. An elastic coupling to be interposed between a first rotary shaft member and a second rotary shaft member which are provided at respective first and second ends with respective first and second sets of fixing members fixed thereto, said elastic coupling comprising a generally planar main rubber body to be interposed between the first and second rotary shaft members, and a reinforcing member embedded within said main rubber body to reinforce said main rubber body for increasing a torsional stiffness of said main rubber body with respect to a torsional load applied thereto in a direction of rotation thereof, said main rubber body having a plurality of first through-holes and a plurality of second through-holes which are alternately arranged at a predetermined angular spacing interval along a circle having a center on a rotation axis of said main rubber body, said fixing members of said first set being fixedly inserted through said first through-holes while said fixing members of said second set being fixedly inserted through said second through-holes, whereby said first and second rotary shaft members are elastically connected to each other by the elastic coupling such that said main rubber body is rotatable with said first and second rotary shaft members, wherein an improvement comprises:
said reinforcing member consisting of a wirework structure formed by bending a single wire of a spring steel, so as to surround said first and second through-holes;
said reinforcing member including a plurality of envelope portions surrounding circumferential portions of the respective first and second through-holes, which circumferential portions are located radially outwardly of said circle and correspond to at least a half of a circumference of each of said through-holes, said envelope portions being spaced apart from circumferential surfaces of said respective first and second through-holes in a radial direction of said each through-hole, by respective rubber layers which partially defines said circumferential surfaces; and
said reinforcing member further including a plurality of spring portions each of which connects adjacent ones of said plurality of envelope portions which are adjacent to each other in a circumferential direction of said circle, each of said spring portions generating a resilient force resisting a relative displacement of said adjacent ones of envelope portions when said relative displacement takes place in said circumferential direction.

2. An elastic coupling according to claim 1, wherein said plurality of envelope portions consist of a plurality of convex portions including respective substantially semicircular parts located radially outwardly of said circle, while said plurality of spring portions consist of a plurality of concave portions including respective intermediate parts located radially inwardly of said circle, said convex and concave portions being alternately arranged along said circle.

3. An elastic coupling according to claim 2, wherein each of said plurality of spring portions further includes a pair of connecting arms which are located on respective opposite sides of said intermediate part and which terminate in the respective two adjacent envelope portions, said pair of connecting arms being formed such that lines of extension of said pair of connecting arms intersect each other at an acute angle.

4. An elastic coupling according to claim 2, wherein said reinforcing member consists of a plurality of loops which are formed of said single wire of the spring steel and which are superposed on each other, each of said plurality of loops including said plurality of concave portions provided as said plurality of spring portions, said intermediate parts of said concave portions of at least one but not all of said plurality of loops have a radius of curvature larger than that of said intermediate parts of said concave portions of the other of said plurality of loops.

5. An elastic coupling according to claim 1, wherein said reinforcing member consists of a plurality of loops which are respectively formed of a plurality of wires of a spring steel and which are superposed on each other, at least one but not all of said plurality of wires having a large diameter than the other of said plurality of wires.

6. An elastic coupling according to claim 1, wherein said reinforcing member consists of a plurality of loops which are formed by respective turns of said single wire of the spring steel and which are superposed on each other, each of said plurality of loops including said plurality of envelope portions and said plurality of spring portions.

7. An elastic coupling according to claim 1, wherein each of said rubber layers formed between said envelope portions of said reinforcing member and said circumferential portions of said first and second through-holes of said main rubber body has at least one cutout formed so as to extend substantially continuously between opposite surfaces of said main rubber body.

8. An elastic coupling according to claim 1, wherein said main rubber body has a plurality of openings which are open in at least one of opposite surfaces of said main rubber body and through which each of said plurality of envelope portions of said reinforcing member is partially exposed to the atmosphere, said main rubber body further having a plurality of annular protrusions formed on each of said at least one of opposite surfaces thereof, each of said annular protrusions surrounding said plurality of openings for the corresponding one of said envelope portions.

9. An elastic coupling according to claim 1, wherein said main rubber body has a plurality of openings which are open in at least one of opposite surfaces of said main rubber body and through which each of said plurality of envelope portions of said reinforcing member is partially exposed to the atmosphere, said main rubber body further having a plurality of annular protrusions formed on each of said at least one of opposite surfaces thereof, said plurality of annular protrusions respectively surrounding said plurality of openings of said plurality of envelope portions.

10. An elastic coupling according to claim 8, wherein said plurality of openings through which each of said plurality of envelope portion is partially exposed to the atmosphere are open in both of said opposite surfaces of said main rubber body, and said plurality of annular protrusions are formed on both of said opposite surfaces.

11. An elastic coupling according to claim 9, wherein said plurality of openings through which each of said plurality of envelope portion is partially exposed to the atmosphere are open in both of said opposite surfaces of said main rubber body, and said plurality of annular protrusions are formed on both of said opposite surfaces.

12. A steering coupling to be interposed between a first rotary shaft portion and a second rotary shaft portion of a steering column of a steering system in an automotive vehicle, said first and second rotary shaft portion being provided at respective first and second ends with respective first and second sets of fixing members fixed thereto, said elastic coupling comprising a generally planar main rubber body to be interposed between the first and second rotary shaft portions, and a reinforcing member embedded within said main rubber body to reinforce said main rubber body for increasing a torsional stiffness of said main rubber body with respect to a torsional load applied thereto in a direction of rotation thereof, said main rubber body having a plurality of first through-holes and a plurality of second through-holes which are alternately arranged at a predetermined angular spacing interval along a circle having a center on a rotation axis of said main rubber body, said fixing members of said first set being fixedly inserted through said first through-holes while said fixing members of said second set being fixedly inserted through said second through-holes, whereby said first and second rotary shaft portions are elastically connected to each other by the steering coupling such that said main rubber body is rotatable with said first and second rotary shaft portions, wherein an improvement comprises:
said reinforcing member consists of a wirework structure formed by bending a single wire of a spring steel, so as to surround said first and second through-holes;
said reinforcing member includes a plurality of envelope portions surrounding circumferential portions of the respective first and second through-holes, which circumferential portions are located radially outwardly of said circle and correspond to at least a half of a circumference of each of said through-holes, said envelope portions being spaced apart from circumferential surfaces of said respective first and second through-holes in a radial direction of said each through-hole, by respective rubber layers which partially defines said circumferential surfaces; and
said reinforcing member further includes a plurality of spring portions each of which connects adjacent ones of said plurality of envelope portions which are adjacent to each other in a circumferential direction of said circle, each of said spring portions generating a resilient force resisting a relative displacement of said adjacent ones of envelope portions when said relative displacement takes place in said circumferential direction.
